(19) United States
(12) Patent Application Publication
(10) Pub. No.: US 2025/0307161 A1
(43) Pub. Date: Oct. 2, 2025

(54) METHOD AND APPARATUS WITH DATA PROCESSING

(71) Applicant: Samsung Electronics Co., Ltd., Suwon-si (KR)

(72) Inventors: Qianbin ZHU, Suwon-si (KR); Yuehua DAI, Xi'an (CN); Bingxu JIN, Xi'an (CN); Rui HUANG, Xi'an (CN); Yayun ZHANG, Xi'an (CN)

(73) Assignee: Samsung Electronics Co., Ltd., Suwon-si (KR)

(21) Appl. No.: 19/069,570

(22) Filed: Mar. 4, 2025

(30) Foreign Application Priority Data
Apr. 2, 2024 (CN) 202410397029.1
Oct. 31, 2024 (KR) 10-2024-0152316

(51) Int. Cl. G06F 12/0862

(52) U.S. Cl. CPC G06F 12/0862; G06F 2212/251

(57) ABSTRACT

A data processing method includes determining an idle memory size of a graphics processing unit (GPU), and based on the idle memory size of the GPU, selectively performing one of transmitting prefetched data of a memory of a central processing unit (CPU) to the GPU, and receiving delayed offload data from the GPU and storing the delayed offload data in the memory of the CPU, wherein the prefetched data comprises input data for an operation to be performed by the GPU, the delayed offload data comprises output data that has not been offloaded after completion of the operation on the GPU, and the transmitting of the prefetched data or the receiving of the delayed offload data is executed in parallel with the operation of the GPU.

### CROSS-REFERENCE TO RELATED APPLICATIONS

This application claims the benefit under 35 USC § 119 (a) of Chinese Patent Application No. 202410397029.1 filed on Apr. 2, 2024 in the China National Intellectual Property Administration, and Korean Patent Application No. 10-2024-0152316 filed on Oct. 31, 2024 in the Korean Intellectual Property Office, the entire disclosures of which are incorporated herein by reference for all purposes.

### BACKGROUND

### 1. Field

The following description relates to a method and apparatus with data processing.

### 2. Description of Related Art

Deep-learning technology may implement a model of a large scale and may demand a large amount of memory for a graphics processing unit (GPU). Prefetching and offloading are methods that move some of the computing-intensive tasks, such as machine learning and artificial intelligence, between a central processing unit (CPU) and a GPU, which may improve the training and operation performance of a large-scale model. The GPU may transmit data generated in an operation process of model data to a host memory (e.g., a memory of the CPU). The data to be used during the operation process may be loaded into a memory of the GPU, and the efficiency of the memory of the GPU may be maximized by deallocating the memory of the GPU or transmitting the data to the memory of the CPU in response to completing the operation process.

The offloading may provide an advantageous effect on large-scale model training but may also negatively affect the performance of model training if data transmission is frequent between a device and a host during the model training. The memory of the GPU may continuously cache data to be used in the next operation and intermediate data generated in response to completing an operation. Thus, frequent data transmission and synchronization of data preparation and operation may negatively affect operation performance and may cause inefficiency in peripheral component interconnect express (PCIe) hardware use. In an operation process of each layer of iterative model training, the GPU may inefficiently wait for data transmission (or copying) while a PCIe interface inefficiently remains idle most of the time.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one or more general aspects, a data processing method includes determining an idle memory size of a graphics processing unit (GPU), and, based on the idle memory size of the GPU, selectively performing one of transmitting prefetched data of a memory of a central processing unit (CPU) to the GPU, and receiving delayed offload data from the GPU and storing the delayed offload data in the memory of the CPU, wherein the prefetched data may include input data for an operation to be performed by the GPU, the delayed offload data may include output data that has not been offloaded after completion of the operation on the GPU, and the transmitting of the prefetched data or the receiving of the delayed offload data is executed in parallel with the operation of the GPU.

The operation of the GPU may include an operation related to a model, the prefetched data may include input data of a layer for the operation related to the model, and the delayed offload data may include output data that has not been offloaded after completion of an operation of a layer of the model.

Based on the idle memory size of the GPU, the transmitting of the prefetched data of the memory of the CPU to the GPU or the receiving of the delayed offload data from the GPU and the storing of the delayed offload data in the memory of the CPU may include identifying a first layer of the model as a prefetch layer and determining whether data prefetching has been completed for the prefetch layer, determining a prefetch memory size depending on an operation progress of the GPU configured to perform the operation related to the model, based on the determining that data prefetching has not been completed for the prefetch layer, and in response to the prefetch memory size being less than or equal to the idle memory size of the GPU, transmitting the input data of the prefetch layer from the memory of the CPU to the memory of the GPU, and in response to the prefetch memory size being greater than the idle memory size of the GPU, receiving the delayed offload data from the memory of the GPU and storing the delayed offload data in the memory of the CPU.

The data processing method may include, in response to the prefetch memory size being greater than the idle memory size of the GPU, and in response to receiving and storing the delayed offload data, based on whether data offloading of all layers of the model has been completed, terminating a current iteration of the operation related to the model, or returning to the determining of whether data prefetching has been completed for the prefetch layer.

The data processing method may include, in response to the prefetch memory size being less than or equal to the idle memory size of the GPU, and in response to the transmitting of the input data of the prefetch layer, identifying a second layer, not the first layer, of the model as a prefetch layer, and repeatedly performing the determining of whether prefetching has been completed, the determining of the prefetch memory size, and the transmitting of the input data of the prefetch layer or the receiving of the delayed offload data.

The data processing method may include, before the determining of the idle memory size of the GPU, determining an input data size of each layer of the model and an output data size of each layer of the model, and the determining of the prefetch memory size depending on an operation progress of the GPU configured to perform the operation related to the model may include identifying a current operation layer of the model that is a target of the operation, and determining the prefetch memory size based on a sum of input data sizes from the current operation layer to the prefetch layer, a size of the delayed offload data, and a sum of output data sizes from the current operation layer to the prefetch layer.

The determining of an input data size of each layer of the model and an output data size of each layer of the model may include determining the input data size of each layer of the model and the output data size of each layer of the model in a first iteration of the operation related to the model.

The determining of the idle memory size of the GPU may include determining a peak value of memory use of the GPU, and determining the idle memory size of the GPU based on a total memory size of the GPU and the peak value of memory use of the GPU.

The determining of the peak value of memory use of the GPU may include, when the transmitting of the prefetched data and the receiving of the delayed offload data is serially performed with the operation related to the model of the GPU in an initial predetermined number of iterations of the operation related to the model, determining the peak value of memory use of the GPU during the initial predetermined number of iterations.

In one or more general aspects, a non-transitory computer-readable storage medium may store code that, when executed by the CPU, configures the CPU to perform any one, any combination, or all of operations, methods, and/or steps of a CPU disclosed herein.

In one or more general aspects, a data processing method includes selectively performing one of receiving prefetched data from a central processing unit (CPU) and storing the prefetched data in a memory of a graphics processing unit (GPU), and transmitting delayed offload data of the memory of the GPU to the CPU, and performing an operation of the GPU in parallel with the receiving and storing of the prefetched data or the transmitting of the delayed offload data, wherein the prefetched data may include input data of the operation to be performed by the GPU, and the delayed offload data may include output data that has not been offloaded after completion of operation on the GPU.

The GPU may include an operation stream and a data copy stream, and the GPU may perform the receiving of the prefetched data and the transmitting of the delayed offload data through the data copy stream and performs the operation of the GPU by receiving an operation task assigned by the CPU through the operation stream.

The operation of the GPU may include an operation related to a model, the prefetched data may include input data of a layer for the operation related to the model, and the delayed offload data may include output data that has not been offloaded after completion of an operation of a layer of the model.

In one or more general aspects, a data processing apparatus includes a central processing unit (CPU) configured to determine an idle memory size of a graphics processing unit (GPU), and, based on the idle memory size of the GPU, selectively perform one of transmitting prefetched data of a memory of the CPU to the GPU, and receiving delayed offload data from the GPU and store the delayed offload data in the memory of the CPU, wherein the prefetched data may include input data for an operation to be performed by the GPU, the delayed offload data may include output data that has not been offloaded after completion of the operation on the GPU, and the transmitting of the prefetched data or the receiving of the delayed offload data is executed in parallel with the operation of the GPU.

The data processing apparatus may include the GPU, wherein the GPU may be configured to selectively perform one of receiving prefetched data from the CPU and store the prefetched data in a memory of the GPU, and transmitting delayed offload data of the memory of the GPU to the CPU, and perform an operation of the GPU in parallel with the receiving and storing of the prefetched data or the transmitting of the delayed offload data.

The operation of the GPU may include an operation related to a model, the prefetched data may include input data of a layer for the operation related to the model, and the delayed offload data may include output data that has not been offloaded after completion of an operation of a layer of the model.

Based on the idle memory size of the GPU, for the transmitting of the prefetched data of the memory of the CPU to the GPU or for the receiving of the delayed offload data from the GPU and the storing of the delayed offload data in the memory of the CPU, the CPU may be configured to identify a first layer of the model as a prefetch layer and determining whether data prefetching has been completed for the prefetch layer, determine a prefetch memory size depending on an operation progress of the GPU configured to perform the operation related to the model, based on the determining that data prefetching has not been completed for the prefetch layer, in response to the prefetch memory size being less than or equal to the idle memory size of the GPU, transmit the input data of the prefetch layer from the memory of the CPU to the memory of the GPU, and in response to the prefetch memory size being greater than the idle memory size of the GPU, receive the delayed offload data from the memory of the GPU and storing the delayed offload data in the memory of the CPU.

The CPU may be configured to, in response to the prefetch memory size being greater than the idle memory size of the GPU, and in response to receiving and storing the delayed offload data, based on whether data offloading of all layers of the model has been completed, selectively perform one of terminating a current iteration of the operation related to the model, and returning to the determining of whether data prefetching has been completed for the prefetch layer.

The CPU may be configured to, in response to the prefetch memory size being less than or equal to the idle memory size of the GPU, and in response to the transmitting of the input data of the prefetch layer, identify a second layer, not the first layer, of the model as a prefetch layer, and repeatedly performing the determining of whether prefetching has been completed, the determining of the prefetch memory size, and the transmitting of the input data of the prefetch layer or the receiving of the delayed offload data.

The CPU may be configured to, before the determining of the idle memory size of the GPU, determine an input data size of each layer of the model and an output data size of each layer of the model, and for the determining of the prefetch memory size depending on the operation progress of the GPU configured to perform the operation related to the model, identify a current operation layer of the model that is a target of the operation, and determine the prefetch memory size based on a sum of input data sizes from the current operation layer to the prefetch layer, a size of the delayed offload data, and a sum of output data sizes from the current operation layer to the prefetch layer.

Other features and aspects will be apparent from the following detailed description, the drawings, and the claims.

### BRIEF DESCRIPTION OF THE DRAWINGS

FIG. 1 illustrates an example of the inefficient use of a graphics processing unit (GPU) and peripheral component interconnect express (PCIe) resources while waiting for data to be used in an operation.

FIG. 2 illustrates an example of data transmission and operation parallelization.

FIG. 3 is a flowchart illustrating a data processing method performed by a central processing unit (CPU), according to one or more embodiments.

FIG. 4 illustrates an example of data transmission and operation parallelization.

FIG. 5 is a flowchart illustrating a data processing method performed by a GPU, according to one or more embodiments.

FIG. 6 is a flowchart illustrating a data processing method according to one or more embodiments.

FIG. 7 is a block diagram illustrating a CPU according to one or more embodiments.

FIG. 8 is a block diagram illustrating a GPU according to one or more embodiments.

FIG. 9 is a diagram illustrating a data processing apparatus according to one or more embodiments.

FIG. 10 is a block diagram illustrating an electronic device according to one or more embodiments.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known after an understanding of the disclosure of this application may be omitted for increased clarity and conciseness.

Although terms such as “first,” “second,” and “third,” or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but is used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Throughout the specification, when a component or element is described as “on,” “connected to,” “coupled to,” or “joined to” another component, element, or layer, it may be directly (e.g., in contact with the other component, element, or layer) “on,” “connected to,” “coupled to,” or “joined to” the other component element, or layer, or there may reasonably be one or more other components elements, or layers intervening therebetween. When a component or element is described as “directly on,” “directly connected to,” “directly coupled to,” or “directly joined to” another component element, or layer, there can be no other components, elements, or layers intervening therebetween. Likewise, expressions, for example, “between” and “immediately between” and “adjacent to” and “immediately adjacent to” may also be construed as described in the foregoing.

The terminology used herein is for describing various examples only and is not to be used to limit the disclosure. The articles “a,” “an,” and “the” are intended to include the plural forms as well, unless the context clearly indicates otherwise. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof, or the alternate presence of an alternative stated features, numbers, operations, members, elements, and/or combinations thereof. Additionally, while one embodiment may set forth such terms “comprise” or “comprises,” “include” or “includes,” and “have” or “has” to specify the presence of stated features, numbers, operations, members, elements, and/or combinations thereof, other embodiments may exist where one or more of the stated features, numbers, operations, members, elements, and/or combinations thereof are not present.

Unless otherwise defined, all terms, including technical and scientific terms, used herein have the same meaning as commonly understood by one of ordinary skill in the art to which this disclosure pertains and based on an understanding of the disclosure of the present application. Terms, such as those defined in commonly used dictionaries, are to be interpreted as having a meaning that is consistent with their meaning in the context of the relevant art and the disclosure of the present application, and are not to be interpreted in an idealized or overly formal sense unless expressly so defined herein. The use of the term “may” herein with respect to an example or embodiment, e.g., as to what an example or embodiment may include or implement, means that at least one example or embodiment exists where such a feature is included or implemented, while all examples are not limited thereto. The use of the terms “example” or “embodiment” herein have a same meaning (e.g., the phrasing “in one example” has a same meaning as “in one embodiment,” and “one or more examples” has a same meaning as “in one or more embodiments”).

As used herein, the term “and/or” includes any one and any combination of any two or more of the associated listed items. The phrases “at least one of A, B, and C”, “at least one of A, B, or C”, and the like are intended to have disjunctive meanings, and these phrases “at least one of A, B, and C”, “at least one of A, B, or C”, and the like also include examples where there may be one or more of each of A, B, and/or C (e.g., any combination of one or more of each of A, B, and C), unless the corresponding description and embodiment necessitates such listings (e.g., “at least one of A, B, and C”) to be interpreted to have a conjunctive meaning.

Hereinafter, embodiments will be described in detail with reference to the accompanying drawings. When describing the embodiments with reference to the accompanying drawings, like reference numerals refer to like elements, and a repeated description related thereto is omitted.

A large-scale model for deep learning may be implemented by a graphics processing unit (GPU)'s memory (or video random-access memory (VRAM)) of one or more embodiments configured to process large amounts of data and parameters.

In data offloading, the GPU may transmit data generated in an operation process of model data to a host memory (e.g., a memory of a central processing unit (CPU)). The data to be used in the operation process may be loaded on the GPU's memory, and the efficiency of the GPU's memory may be maximized by deallocating a space corresponding to the generated data of the GPU's memory or transmitting the data to the CPU's memory in response to completing the operation process. For example, some of the offloading methods may fully transmit parameters, activation, gradient, and optimizer state information to the host memory and may use the GPU's memory as an operation cache. The GPU of one or more embodiments may reduce the memory requirements of large-scale models by loading the data to be used in the operation process in real time from the host memory via peripheral component interconnect express (PCIe).

In a model training process, frequent data transmission between a device (e.g., the GPU) and a host (e.g., the CPU) may affect the performance of model training. When GPU's memory continuously caches data to be used in the next operation process and intermediate data generated in response to completing the operation, frequent data transmission and synchronization of data preparation and operation may affect operation performance and may cause inefficiency in PCIe hardware use.

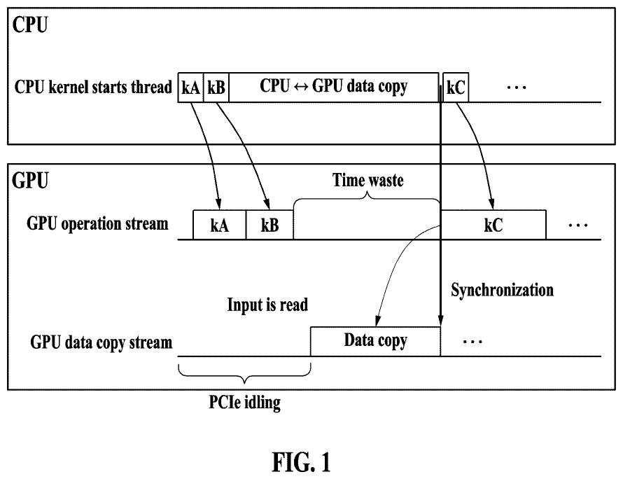

FIG. 1 illustrates an example of the inefficient use of a GPU and PCIe resources while waiting for data to be used in an operation.

During the operation of each layer of iterative model training, a typical GPU may wait until the data to be used in the operation is copied (or transmitted or loaded). For example, referring to FIG. 1, the operation stream of the typical GPU may wait for data copying from after the completion of a kB operation until the start of a kC operation. Meanwhile, referring to FIG. 1, the PCIe may be mostly idle in the data copy stream of the typical GPU. In contrast, a method of one or more embodiments may use GPU and PCIe resources fully in parallel.

According to one or more embodiments, a data processing method and a data processing apparatus of one or more embodiments may execute data transmission and operation, may sufficiently use the idle memory of the GPU, and may preload data from a CPU's memory to the GPU's memory, which may improve operation performance. The data processing method and the data processing apparatus of one or more embodiments may improve the performance of model training through data preparation in the data processing for training large-scale models, the synchronization of operations, and the unbalanced use of PCIe transmission bandwidths. In the present disclosure, data ‘preparation’ may be understood as data ‘transmission’, ‘copying’, and/or ‘loading’ between the CPU and the GPU, and these terms may be interchangeably used.

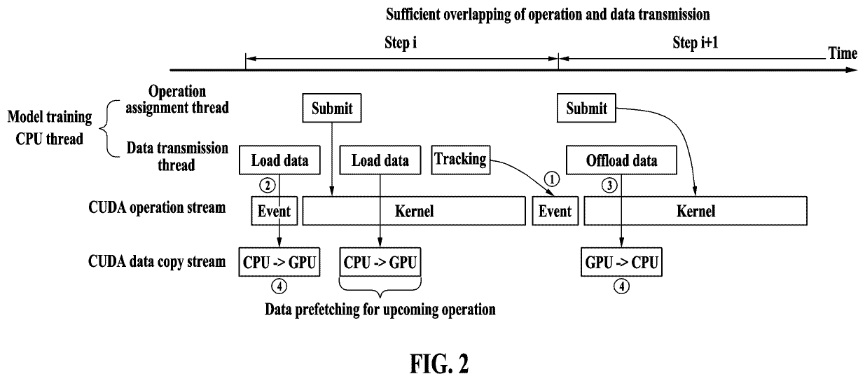

According to one or more embodiments, the CPU may separate data transmission and task (e.g., an operation task) assignment (or scheduling) into different threads and may monitor the progress of a GPU-side operation task in a data transmission thread in real time. The CPU of one or more embodiments may dynamically perform maximum data prefetching by determining the idle memory size of the GPU and may improve operation execution efficiency. The GPU may separate data transmission and operation into different streams and may asynchronously perform the data transmission and the operation in parallel through sophisticated synchronization between the streams. For example, a stream may include a compute unified device architecture (CUDA) stream. From the perspective of the use of PCIe bandwidth resources, multiple threads of the CPU and multiple streams (e.g., multiple CUDA streams) of the GPU may perform data transmission by sufficiently using the PCIe bandwidth resources, and the GPU may perform data prefetching in parallel while executing an operation task. In the present disclosure, based on the technology for extending the GPU's memory to the CPU's memory for an operation, by realizing data exchange between the memories of the GPU and the CPU and the maximum parallelization of GPU operation, the data processing method and the data processing apparatus of one or more embodiments may improve operation execution efficiency, and may improve the performance of large-scale model operation when processing an operation scenario of a large-scale model. Hereinafter, examples of the data processing method and the data processing apparatus are described in detail with reference to FIGS. 2 to 10.

FIG. 2 illustrates an example of data transmission and operation parallelization.

An example of the specific application of a data processing method, according to one or more embodiments, is described with reference to FIG. 2, and it should be understood that the data processing method may be applied to a process involving data interaction between a CPU and a GPU, other than model training. The model training may include forward operation, backward operation, and parameter updates. During the forward operation and the backward operation, data may be loaded from the CPU's memory to the GPU's memory or may be offloaded from the GPU's memory to the CPU's memory. For example, during the forward operation, a parameter of each layer of a model may be loaded from the CPU's memory to the GPU's memory, and multiple activations generated in each layer of the model may be offloaded from the GPU's memory to the CPU's memory. During the backward operation, a parameter of each layer of the model and multiple activations of the forward operation may be loaded from the CPU's memory to the GPU's memory, and a parameter gradient generated in each layer of the model may be offloaded from the GPU's memory to the CPU's memory.

FIG. 2 illustrates a parallel operation mode of GPU operation and data transmission between the CPU's memory and the GPU's memory. Referring to FIG. 2, the CPU may have an operation (e.g., an operation task) assignment thread and a data transmission thread, and the GPU may have an operation stream (e.g., a CUDA operation stream) and a data copy stream (e.g., a CUDA data copy stream). For example, the operation assignment thread and the data transmission thread on the CPU side may be executed in two CPUs, respectively. The operation stream and the data copy stream on the GPU side may be executed in the same GPU. Accordingly, the model training may be performed in a server (or electronic device) of 2 CPUs+1 GPU, 4 CPUs+2 GPUs (4 threads and 4 streams), or 8 CPUs+4 GPUs (8 threads and 8 streams). The foregoing examples are just examples, but the present disclosure is not limited thereto. For example, when a single CPU includes multiple cores, the operation assignment thread and the data transmission thread may be executed in two of the multiple cores, respectively.

The operation assignment thread of the CPU may execute the operation of the model by assigning (or submitting or scheduling) an operation task to the operation stream of the GPU. The CPU's data transmission thread and the GPU's data copy stream may be used for data transmission (or copying), including data loading (e.g., data prefetching) from the CPU's memory to the GPU's memory and data offloading from the GPU's memory to the CPU's memory. For example, in the iterative training of the model, a data transmission thread and a data copy stream may perform data transmission layer by layer, and the CPU's operation assignment thread may assign an operation task to the GPU's operation stream layer by layer to execute the operation of the model. The present disclosure may realize the maximum parallelization of data transmission and operation through multiple threads and multiple streams (e.g., multiple CUDA streams). Referring to FIG. 2, data transmission (e.g., of the CPU's data transmission thread) may sufficiently overlap with operation (e.g., of the GPU's operation stream).

Referring to FIG. 2, the operation of two steps (e.g., a step i and a step i+1) over time during the model training may correspond respectively to two layers of the model. For example, the model may be a deep learning model including a multi-layer structure, such as a convolutional neural network (CNN) model, a recurrent neural network (RNN) model, a generative adversarial networks (GANs) model, a long short-term memory network (LSTM) model, a residual network (ResNet) model, an attention mechanism model, a transformer model, and/or a generative pre-trained transformer (GPT) model, but the present disclosure is not limited thereto, and the model may be any other types of machine-learning models. The main operations and processes are as follows:

Number \textcircled{1} represents the operation that “the CPU's data transmission thread tracks the GPU's operation progress” and the implementation process of this operation may include the following:
1. When executing the model training, a placeholder (e.g., a CUDA event) may be added between layers of the model; and
2. The CPU's data transmission thread may track the execution progress of a GPU-side operation task in real time based on the state of the placeholder. For example, the CPU may set a CUDA event regarding the start and/or completion of a task executed on the GPU via a CUDA application programming interface (API) and may wait until the set CUDA event occurs. For example, the GPU may generate a CUDA event at the start or completion of the task.

Number \textcircled{2} represents the operation that “the CPU's data transmission thread preloads (or prefetches) model data (e.g. prefetched data)” and the implementation process of this operation may include the following:
1. The data transmission thread may identify a current operation layer of the GPU in real time;
2. The data transmission thread may determine the idle memory size of the GPU; and
3. The data transmission thread may preload (or prefetch) model data.

Number \textcircled{3} represents the operation that “the CPU's data transmission thread offloads intermediately generated data” and the implementation process of this operation may include the following: the data transmission thread may offload intermediate data generated during the model training.

Number \textcircled{4} represents the operation that “the GPU's data copy stream (e.g., a CUDA data copy stream) executes data copying” and the implementation process of this operation may include the following: The data copy stream may execute data copying through a PCIe interface, including data copying from the GPU's memory to the CPU's memory and data copying from the CPU's memory to the GPU's memory.

The data transmission thread may prefetch model data to be used by the GPU for the operation of the model and may offload the intermediately generated data (e.g., output data of a layer). Accordingly, by the CPU offloading the intermediately generated data, the GPU may no longer have to wait for data copying for the operation of the model, and the CPU and the GPU of one or more embodiments may thus significantly improve the efficiency of the model training as PCIe transmission bandwidths are sufficiently used. It should be understood that the data transmission and operation parallelization of FIG. 2 are just an example, and the present disclosure is not limited thereto.

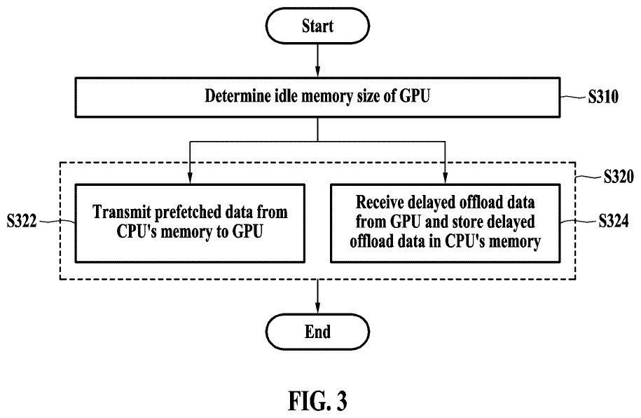

FIG. 3 is a flowchart illustrating a data processing method performed by a CPU, according to one or more embodiments.

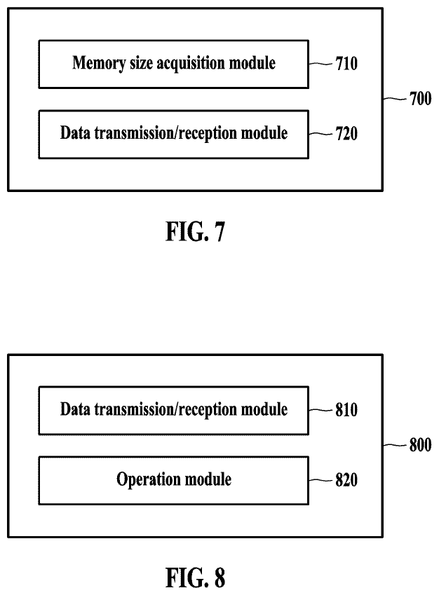

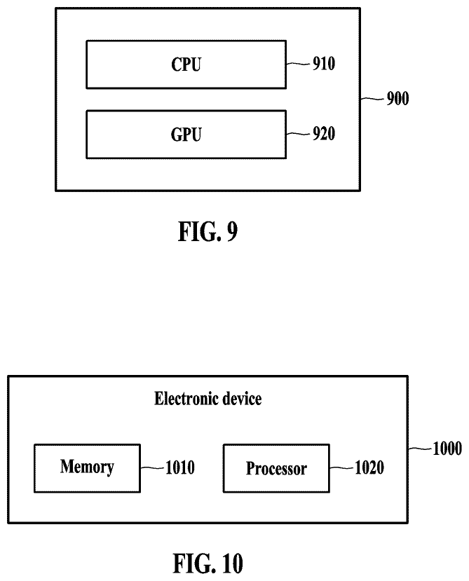

In step S310, the CPU (e.g., a CPU 700 of FIG. 7 or a CPU 910 of FIG. 9) may determine the idle memory size of a GPU (e.g., a GPU 800 of FIG. 8 or a GPU 920 of FIG. 9). Before performing data prefetching and/or data offloading, the CPU may determine the idle memory size of the GPU.

In step S320, in response to the determining of the idle memory size of the GPU, the CPU may perform data prefetching S322 and/or data offloading S324 based on the determined idle memory size of the GPU.

In step S322 of step S320, the CPU may transmit prefetched data from the CPU's memory to the GPU based on the determined idle memory size of the GPU. Before the GPU performs operation, the CPU may perform data prefetching, which prefetches input data (or prefetched data) to be used in the operation to be performed by the GPU from the CPU's memory to the GPU's memory, based on the idle memory size of the GPU. Accordingly, when performing the operation, the GPU of one or more embodiments does not need to wait for data copying, and thus, the GPU of one or more embodiments may reduce the latency of the operation.

In step S324 of step S320, the CPU may receive delayed offload data from the GPU based on the determined idle memory size of the GPU and may store the received delayed offload data in the CPU's memory. Based on the idle memory size of the GPU, data offloading may be performed such that output data (or delayed offload data) that has not been offloaded yet after the completion of the operation on the GPU may be offloaded from the GPU's memory to the CPU's memory. For example, the CPU may receive the delayed offload data from the GPU's memory and may store the received delayed offload data in the CPU's memory. In response to the completion of data offloading, the GPU may deallocate a corresponding space in the memory and the space may be used to prefetch more amount of data or may continue to be used for the next data prefetching. In addition, data offloading may prevent memory use overflow that may be generated when the GPU performs the operation.

The prefetched data may include input data for an operation to be performed by the GPU. The delayed offload data may include output data that has not been offloaded after the completion of the operation on the GPU.

According to one or more embodiments, the CPU may perform data prefetching when the idle memory size of the GPU satisfies a set condition (e.g., when the idle memory size of the GPU is less than or equal to a threshold value). When the idle memory size of the GPU satisfies the set condition, the CPU may perform data offloading. For example, by comparing the idle memory size of the GPU and prefetch memory size, the CPU may perform data prefetching or data offloading. The prefetch memory size may be related to at least one among the size of prefetched data, the size of delayed offload data, and/or output data after the completion of an operation. For example, the prefetch memory size may be determined based on the size of prefetched data, the size of delayed offload data, and/or output data after the completion of the operation. The prefetch memory size may be a sum of the size of prefetched data, the size of delayed offload data, and/or output data after the completion of the operation. For example, the CPU may perform data prefetching when the prefetch memory size is less than or equal to (or is less than) the idle memory size of the GPU. The CPU may perform data offloading when the prefetch memory size is greater than or equal to (or exceeds) the idle memory size of the GPU.

Data transmission (or reception) (e.g., the transmitting of prefetched data and/or the receiving of delayed offload data) between the CPU and the GPU may be performed in parallel with the operation of the GPU. Data transmission may include the transmission (e.g., data prefetching) of prefetched data and/or the reception (e.g., data offloading) of delayed offload data. The CPU may include a data transmission thread and an operation assignment thread, in which the data transmission thread is used to perform data transmission, and the operation assignment thread may be used to perform the operation by assigning an operation task to the GPU. While data prefetching and/or data offloading is performed, the GPU may perform the operation based on prefetched data (e.g., input data for which data prefetching has been completed). Accordingly, PCIe bandwidth resources may be sufficiently used, and the operation performance efficiency of the GPU of one or more embodiments may be improved.

According to one or more embodiments, the operation of the GPU may be or include an operation related to a model. Prefetched data may include input data of a layer of the model for the operation related to the model. Delayed offload data may include output data that has not been offloaded after the completion of an operation of the layer of the model.

The operation related to the model may include an operation related to model training, an operation related to model inference, an operation related to model use, and/or an operation related to model updates, but examples are not limited thereto. For example, the operation related to model training may include the forward or backward operation of the model training.

According to one or more embodiments, the CPU may determine a peak value of the memory use of the GPU. The CPU may determine the idle memory size of the GPU based on the total memory size of the GPU and the peak value of the memory use of the GPU. The determining of the peak value of the memory use of the GPU may include, when the transmitting of the prefetched data and the receiving of the delayed offload data is serially performed with the operation related to the model of the GPU in the initial predetermined number of iterations of the operation related to the model, determining the peak value of the memory use of the GPU during the initial predetermined number of iterations.

The peak value of the memory use of the GPU may be the maximum memory use of the GPU. Regarding the use of the idle memory of the GPU, an example of a method for maximizing the use of the idle memory of the GPU is set forth. The method may be divided into two steps: 1) The operation related to the model may be iterated (e.g., the initial predetermined number of iterations of the operation related to the model) in a manner that the data transmission and an operation of the GPU are performed serially. The CPU may determine the peak value of the memory use of the GPU during the iterations of the operation. 2) The iterations of operations related to a subsequent model may be switched to a data prefetch mode (or a preload mode), and the CPU may maximally prefetch data to be determined based on the idle memory size of the GPU. The CPU may determine the difference between the total memory size of the GPU and the peak value of the memory use of the GPU to be the idle memory size of the GPU.

In step 1) above, the CPU may determine the peak value of the memory use of the GPU through an API provided by a model operation (e.g., training) framework. For example, the peak value of the memory use of the GPU determined during the iterations of the operation related to the model may be the maximum memory use of the GPU in an iteration among the initial predetermined number of iterations, the maximum memory use of the GPU in the whole initial predetermined number of iterations, and/or the maximum memory use of the GPU acquired in other methods, but examples are not limited thereto. The predetermined number may be a default value, an empirical value, and/or a configuration value, e.g., 2 or 3, but examples are not limited thereto.

In step 2) above, the data prefetching and the operation related to the model continue to dynamically use the GPU's memory, and excessive data prefetching may cause the shortage of memory to be used for the subsequent operation. To avoid memory shortage, a method of one or more embodiments of combining static operation and dynamic memory monitoring is set forth. The idle memory use of the GPU for data prefetching (or preloading) may be maximized while avoiding memory use overflow.

According to one or more embodiments, the CPU may determine the input data size of each layer of the model and the output data size of each layer of the model. The memory size used for the data of each layer of the model may be acquired through static operation (or static model analysis). For example, the memory size used by the data of each layer may be acquired in the first iteration of the operation (e.g., training) related to the model. The memory size used by the data of each layer of the model may include the size (e.g., the input data size of a layer) of load data to be used in the operation of the layer and the size (e.g., the output data size of the layer) of data generated in response to the operation of the layer.

Dynamic memory monitoring may use a placeholder (e.g., a CUDA event) displaying the progress of the operation related to the model. The CPU's data transmission thread may acquire the operation progress (e.g., a current operation layer) of the GPU by monitoring the state of the placeholder and may additionally preload (or prefetch) the data of a layer to be subsequently determined by using a memory space deallocated from a layer for which operation has been completed. In a data prefetching mode, during the iterative operation (e.g., training) of the model, by preloading the input data of a layer to be determined, the GPU of one or more embodiments may no longer need to wait for data copying when determining the layer such that the efficiency of model operation (e.g., training) may be significantly improved. For example, the input data may include a parameter of each layer of the model in forward operation and may include a parameter of each layer of the model and multiple activations of the forward operation in backward operation.

While data prefetching is performed, the GPU may perform the operation related to the model in parallel based on prefetched data (e.g., the input data of a layer for which prefetching has been completed). After the data prefetching is completed, the operation of some layers may be already completed. The GPU may offload output data, which has not been offloaded to the CPU yet, of a layer for which the operation of the model has been completed. For example, the GPU may offload a piece of offload data from the GPU's memory to the CPU's memory.

For example, the progress of data offloading is described through a delayed offload layer (e.g., a layer L_{d}). Starting from a first layer of the model, when the operation of the first layer is completed (e.g., L_{d}<L_{c}, in which a layer L_{c} is the current operation layer), if data offloading is to be performed, delayed offload data is offloaded, and, when the offloading is successful, the delayed offload layer may be the next layer (e.g., L_{d}=L_{d}+1). As the operation continues, once the operation of all layers in the current iteration is completed, the output data, which has not been offloaded yet, for all the layers of the model may be offloaded (e.g., from L_{d} to the last layer of the model). In response to the data offloading being completed, a corresponding space of the GPU's memory may be deallocated and may be used for data prefetching in the next iteration. For example, the output data may include multiple activations generated in each layer of the model in forward operation and may include a parameter gradient generated in each layer of the model in backward operation.

Hereinafter, an example of the detailed operation of data prefetching is described.

According to one or more embodiments, the CPU may explore each layer of the model as a prefetch layer. For each prefetch layer, the CPU may perform: an operation of determining prefetch memory size depending on the operation progress of the GPU that performs the operation related to the model; an operation of transmitting the input data of the prefetch layer from the CPU's memory to the GPU's memory when the prefetch memory size is less than or equal to the idle memory size of the GPU; and an operation of receiving delayed offload data from the GPU's memory and storing the received delayed offload data in the CPU's memory when the prefetch memory size is greater than the idle memory size of the GPU.

According to one or more embodiments, the CPU may identify the current operation layer of the model, which is the target of the operation. The CPU may determine the prefetch memory size based on a sum of the input data sizes from the current operation layer to the prefetch layer, the size of the delayed offload data, and a sum of the output data sizes from the current operation layer to the prefetch layer.

In the iterative operation (e.g., training) of the model, the CPU may perform data prefetching layer by layer. The CPU may maximize the amount of prefetched data based on the idle memory size of the GPU. For example, regarding the iteration of the operation related to model training, an iteration may refer to an epoch. The CPU may explore each layer of the model in a current iteration as a prefetch layer. For each prefetch layer, the CPU may determine the prefetch memory size and may compare the determined prefetch memory size with the idle memory size of the GPU. For example, when each prefetched data is loaded on the GPU's memory, the CPU may determine whether memory use overflow occurs when the GPU performs the operation related to the model. A prefetch layer (e.g., a layer Lₚ) may indicate the progress of data prefetching. Since the target of data prefetching is input data for a layer (or a layer for which operation is expected) to be determined in the model, the GPU may fetch the current operation layer (e.g., the layer L_{c}, L_{c}<Lₚ) that performs the operation. Referring to Table 1 below, for example, the input data and output data of the model may be divided into the following four states:

TABLE 1

| Data type | Data state | Description |
|---|---|---|
| Input | Already deallocated | Data space has already been deallocated. |
| data | Already prefetched | Input data to be determined |
| | | is stored in data space. |
| Output | Delayed offload | Delayed offload data is stored |
| data | | in data space. |
| | Offload reserved | Data space is reserved for |
| | | output data to be generated in |
| | | response to operation. |

Referring to Table 1, data types may be classified into already deallocated input data, already prefetched input data, delayed offload data, and offload reserved output data.

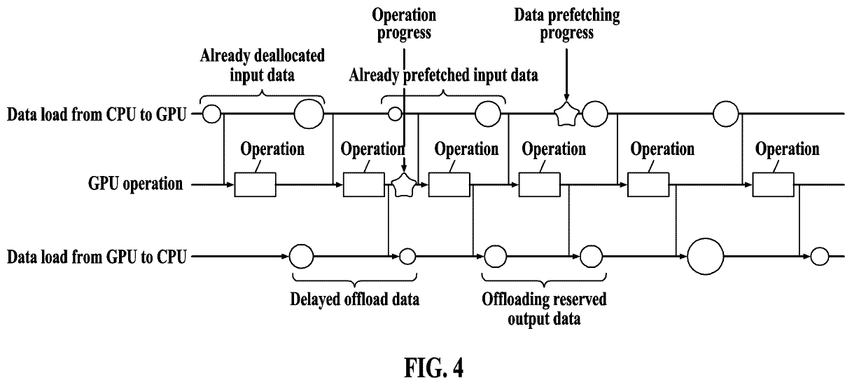

FIG. 4 illustrates another example of data transmission and operation parallelization. Referring to FIG. 4, a horizontal line corresponding to ‘GPU operation’ may indicate that a GPU-side operation stream (e.g., a CUDA operation stream) performs operations related to a model, and each operation may refer to operation for a layer of the model. A horizontal line corresponding to ‘data load from CPU to GPU’ may indicate that data is loaded from the CPU to the GPU, e.g., the progress of data prefetching. A horizontal line corresponding to ‘data load from GPU to CPU’ may indicate that the data is loaded from the GPU to the CPU, e.g., the progress of data offloading.

Referring to FIG. 4 and Table 1, the already deallocated input data is considered the input data of an already determined layer, and a corresponding memory space of the GPU is considered already deallocated, which does not need to be considered when determining prefetch memory size. The already prefetched input data may refer to the prefetched input data of a layer to be determined. The input data to be determined may be stored in a corresponding data space. The delayed offload data (e.g., delayed offload output data) may refer to the output data, which has not been offloaded yet, of the already determined layer, and the offload reserved output data may refer to output data to be generated in response to an operation in a layer to be determined. It should be understood that the data transmission and operation parallelization as shown in the drawing are just an example, and the present disclosure is not limited thereto.

According to one or more embodiments, an example of the method of determining prefetch memory size while the input data of a prefetch layer (e.g., a layer Lₚ) has already been prefetched to the GPU's memory is described. The prefetch memory size may be determined through a sum of the following items: a sum of the input data sizes from the current operation layer to the prefetch layer, the size of the delayed offload data, and a sum of the output data sizes from the current operation layer to the prefetch layer.

The sum (the sum of the input data sizes from a layer L_{c} to the layer Lₚ) of the input data sizes from the current operation layer to the prefetch layer may be the input data size (the input data size of the layer L_{c}) of the current operation layer+the already prefetched input data size (the sum of the input data sizes from a layer L_{c+1} to the layer Lₚ) of Table 1. The size of the delayed offload data may be the delayed offload data of Table 1. The sum (the sum of the output data sizes from the layer L_{c} to the layer Lₚ) of the output data sizes from the current operation layer to the prefetch layer may be the output data size (the output data size of the layer L_{c}) of the current operation layer+the offload reserved output data size (the sum of the output data sizes from the layer L₊₁ to the layer Lₚ) of Table 1.

In addition, the input data and output data of the current operation layer of the model may also occupy the GPU's memory, and thus, the input data and output data of the current operation layer L_{c} may also be used to determine the prefetch memory size. In addition, the sum of the size of the delayed offload data and the sum of the output data sizes from the current operation layer to the prefetch layer may be the sum (e.g., the sum of the output data sizes from the layer L_{d} to the layer Lₚ) of the output data sizes from the delayed offload layer to the prefetch layer.

According to one or more embodiments, when the prefetching memory size is less than or equal to the idle memory size of the GPU, the CPU may transmit the input data of the prefetch layer from the CPU's memory to the GPU's memory. Accordingly, the input data (e.g., a parameter of the prefetch layer in forward operation) of the prefetch layer may be preloaded on the GPU's memory. According to one or more embodiments, when the prefetch memory size is greater than the idle memory size of the GPU, the CPU may receive delayed offload data from the GPU's memory and may store the received delayed offload data in the CPU's memory. Accordingly, the output data, which has not been offloaded yet, of the determined layer may be offloaded to the CPU's memory. Since data transmission is performed in parallel with operation, while data prefetching is performed, the GPU may perform the operation related to the model based on prefetched data (e.g., the input data of a layer for which prefetching has been completed).

When the prefetch memory size of the prefetch layer is greater than the idle memory size of the GPU, referring to Table 1, the GPU's memory may still include delayed offload data. Data prefetching may be maximized by offloading the delayed offload data to the CPU's memory. Accordingly, by performing data offloading, a corresponding memory space of the GPU's memory may be deallocated. In addition, when the data offloading of a layer is completed, the progress of the data offloading may be updated. Once the data offloading is completed, the CPU may redetermine the prefetch memory size for the prefetch layer. By comparing the redetermined prefetch memory size with the idle memory size of the GPU again, the CPU may determine whether to perform the data prefetching of the prefetch layer.

According to one or more embodiments, a data processing method of one or more embodiments may maximize the parallelization of data transmission and operation by generating the CPU's multiple threads and the GPU's multiple streams (e.g., multiple CUDA streams) and may eliminate performance degradation due to data transmission latency by sufficiently using PCIe bandwidth resources. Meanwhile, the data processing method may store prefetched data to be used in the operation of the GPU and delayed offload data generated during the operation by dynamically monitoring and maximally using the GPU's idle memory. The data processing method of one or more embodiments may maximize the GPU's operation efficiency by executing data offloading in a timely manner depending on whether the GPU's memory is insufficient and whether the prefetched data is sufficient for the GPU's operation.

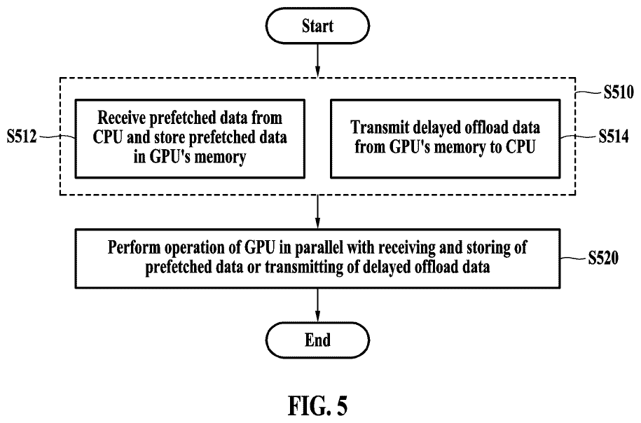

FIG. 5 is a flowchart illustrating a data processing method performed by a GPU, according to one or more embodiments.

In step S510, the GPU (e.g., the GPU 800 of FIG. 8 or the GPU 920 of FIG. 9) may receive prefetched data from a CPU (e.g., the CPU 700 of FIG. 7 or the CPU 910 of FIG. 9), may store, in step S512 of step S510, the received prefetched data in the GPU's memory, or may transmit, in step S514 of step S510, delayed offload data from the GPU's memory to the CPU.

In step S520, the GPU may perform the operation of the GPU in parallel with the receiving and storing of the prefetched data or the transmitting of the delayed offload data. The prefetched data may include input data for an operation to be performed by the GPU. The delayed offload data may include output data that has not been offloaded yet after the completion of the operation on the GPU.

Before performing the operation, the GPU may receive and store, in step S512, the input data of the operation to be performed by the GPU through data prefetching. Since the GPU receives the prefetched data from the CPU's memory and stores the received prefetched data in the GPU's memory, the GPU of one or more embodiments may not need to wait for data copying when performing the operation, and thus, the latency of the operation may be reduced.

The GPU may perform data offloading in step S514, which may be the transmitting of the delayed offload data from the GPU's memory to the CPU. Once the data offloading is completed, the GPU may deallocate a corresponding space of the memory, and the space may be used for more data prefetching or may continue to be used for the next data prefetching. The data offloading of one or more embodiments may prevent memory use overflow that may be generated when the GPU performs the operation.

According to one or more embodiments, the GPU may include an operation stream (e.g., a CUDA operation stream) and a data copy stream (e.g., a CUDA data copy stream). The data copy stream may be used to receive the prefetched data and transmit the delayed offload data, and the operation stream may perform corresponding operation by receiving an operation task assigned by the CPU.

Data transmission (or reception) (e.g., the receiving of the prefetched data and/or the transmitting of the delayed offload data) between the CPU and the GPU may be performed in parallel with the operation of the GPU. Data transmission may include the reception (e.g., data prefetching) of the prefetched data and/or the transmission (e.g., data offloading) of the delayed offload data. While data prefetching or data offloading is performed, the GPU may perform an operation based on prefetched data (e.g., input data for which data prefetching has been completed).

According to one or more embodiments, the operation of the GPU may be or include an operation related to a model. Prefetched data may include input data of a layer of the model for the operation related to the model. Delayed offload data may include output data that has not been offloaded after the completion of an operation of the layer of the model.

The operation related to the model may include an operation related to model training, an operation related to model inference, an operation related to model use, and/or an operation related to model updates, but examples are not limited thereto. For example, the operation related to model training may include the forward or backward operation of the model training.

According to one or more embodiments, a data processing method of one or more embodiments may maximize the parallelization of data transmission and operation by generating the CPU's multiple threads and the GPU's multiple streams (e.g., multiple CUDA streams) and may eliminate performance degradation due to data transmission latency by sufficiently using PCIe bandwidth resources. Meanwhile, the data processing method may store prefetched data to be used in the operation of the GPU and delayed offload data generated during the operation by dynamically monitoring and maximally using the GPU's idle memory. The data processing method of one or more embodiments may maximize the GPU's operation efficiency by executing data offloading in a timely manner depending on whether the GPU's memory is insufficient and whether the prefetched data is sufficient for the GPU's operation.

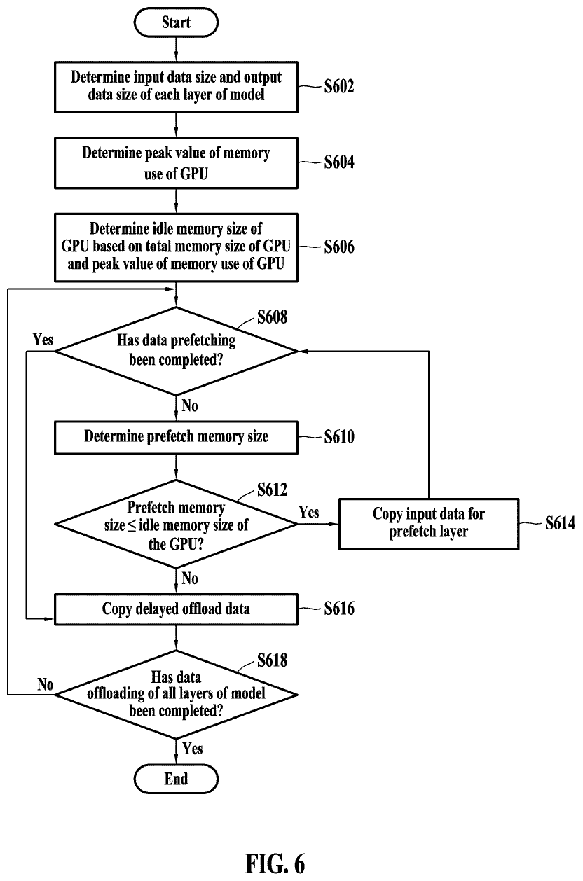

FIG. 6 is a flowchart illustrating a data processing method according to one or more embodiments.

In step S602, a CPU (e.g., the CPU 700 of FIG. 7 or the CPU 910 of FIG. 9) may determine the input data size of each layer of a model and the output data size of each layer of the model. For example, the CPU may determine and acquire the input data size of each layer of the model and the output data size of each layer of the model in a first iteration of operations (e.g., training) related to the model. In one or more embodiments, the CPU may store the acquired input data size and output data size of each layer in an array or list form and may be used for a subsequent operation.

In step S604, the CPU may determine a peak value of the memory use of a GPU (e.g., the GPU 800 of FIG. 8 or the GPU 920 of FIG. 9). When data transmission (e.g., the transmitting of prefetched data and the receiving of delayed offload data) between the CPU's memory and the GPU's memory is serially performed with the operation (e.g., training) related to the model of the GPU in the initial predetermined number of iterations of the operation related to the model, the CPU may determine the peak value of the memory use of the GPU during the iterations.

In step S606, the CPU may determine the idle memory size of the GPU based on the total memory size of the GPU and the peak value of the memory use of the GPU. For example, the CPU may determine the difference between the total memory size of the GPU and the peak value of the memory use of the GPU to be the idle memory size of the GPU.

In step S608, the CPU may identify a first layer of the model as a prefetch layer and may determine whether data prefetching has been completed for the prefetch layer.

The CPU may perform step S610 in response to determining that the data prefetching has not been completed for the prefetch layer. The CPU may perform step S616 in response to determining that the data prefetching has been completed for the prefetch layer.

In step S610, the CPU may determine prefetch memory size depending on the operation progress of the GPU that performs the operation related to the model for the prefetch layer. The CPU may identify the current operation layer of the model that is a target of the operation. The prefetch memory size may be determined through a sum of the following three items: a sum of the input data sizes from the current operation layer to the prefetch layer, the size of the delayed offload data, and a sum of the output data sizes from the current operation layer to the prefetch layer.

In step S612, the CPU may compare the idle memory size of the GPU with the prefetch memory size. The CPU may perform step S614 when the prefetch memory size is less than or equal to (or is less than) the idle memory size of the GPU. The CPU may perform step S616 when the prefetch memory size exceeds (or is greater than or equal to) the idle memory size of the GPU.

In step S614, the CPU may copy (or transmit) the input data for the prefetch layer from the CPU's memory to the GPU's memory. For example, the CPU may perform the data prefetching for the prefetch layer. For example, the CPU may execute the PCIe data copying of the input data for the prefetch layer. Through the data prefetching of the prefetch layer, the input data of the prefetch layer may be loaded from the CPU's memory to the GPU's memory.

When the data prefetching of the prefetch layer is successful, e.g., in response to the transmitting of the input data of the prefetch layer, the CPU may identify a second layer, not the first layer, of the model as a prefetch layer, and may repeatedly perform step S608 of determining whether prefetching has been completed, step S610 of determining the prefetch memory, step S612 of comparing the idle memory size with the prefetch memory size, step S614 of transmitting the input data of the prefetch layer, or step S616 of receiving the delayed offload data. For example, the CPU may identify the next layer (e.g., a layer Lₚ₊₁) of the prefetch layer (e.g., a layer Lₚ) as the prefetch layer and may perform step S608 again.

The CPU may identify all layers of the model as prefetch layers and may determine whether determining has been completed, in which the determining is determining whether prefetching has been completed. For example, when the model includes the total of N layers, and when Lₚ<L_{N} (e.g., p<N), the CPU may determine that the determining has not been completed for a layer (e.g., Lₚ) identified as the prefetch layer. When the determining has not been completed, and the data prefetching of the next layer has not been completed, the CPU may perform step S610, and, when the determining has been completed, the CPU may perform step S616.

In step S616, the CPU may copy (or receive) the delayed offload data from the GPU's memory and may store the copied delayed offload data in the CPU's memory. For example, the CPU may execute the PCIe data copying of the delayed offload data. Through the offloading of the delayed offload data, the delayed offload data may be offloaded from the GPU's memory to the CPU's memory. A memory space corresponding to the delayed offload data of the GPU's memory may be deallocated.

In step S618, in response to step S616 of receiving and storing the delayed offload data, the CPU may determine whether the data offloading of all the layers of the model has been completed. The completion of the data offloading of all the layers may be that data is output in response to operations for all the layers is completed in a current iteration of the operation related to the model and the current iteration is terminated as the output data of all the layers is copied from the GPU to the CPU. Based on whether the data offloading of all the layers of the model has been completed, the CPU may terminate the current iteration of the operation related to the model or may return to step S608 of determining whether the data prefetching has been completed for the prefetch layer.

For example, when the prefetch memory size exceeds (or is greater than or equal to) the idle memory size of the GPU in step S612 (e.g., No), steps S616 and S618 are performed. In this case, operation and data offloading may not have been completed for all the layers of the model. Returning to step S608, the data processing method may determine data prefetching has not been completed for the prefetch layer of the model and may perform steps S610 and S612. Since the offloading of the delayed offload data is executed in step S616 previously, the prefetch memory size determined in step S610 may be reduced. Accordingly, when the prefetch memory size is less than or equal to (or exceeds) the idle memory size of the GPU in step S612, the data processing method may perform step S614 to complete data prefetching for a corresponding layer (e.g., the prefetch layer).

For example, when the data prefetching for the prefetch layer of the model has been completed in step S608 (e.g., Yes), step S616 is performed. In this case, data prefetching has been completed for all the layers of the model, but the operation related to the model may not have been completed. While the operation related to the model is performed, in step S616, the output data, which has not been offloaded yet, of the layer for which the operation has been completed may be offloaded. Ultimately, in response to the operations for all the layers of the model being completed, in step S616, the data offloading of all the layers may be completed. The data processing method performs step S618, and the CPU determines that the data offloading of all the layers of the model is completed such that the current iteration (e.g., training) of the operation related to the model may be terminated.

In the flowchart of FIG. 6, steps S602 to S606 may be performed once for the operation (e.g., training) related to the model. Steps S608 to S618 may be performed during one iteration (or an epoch) of the operation related to the model. During multiple iterations of the operation related to the model, steps S608 to S618 may be performed repeatedly until the operation (e.g., training) related to the model is completed.

FIG. 7 is a block diagram illustrating a CPU according to one or more embodiments.

According to one or more embodiments, the CPU 700 may include a memory size acquisition module 710 and a data transmission/reception module 720. The memory size acquisition module 710 may determine the idle memory size of a GPU (e.g., the GPU 800 of FIG. 8 or the GPU 920 of FIG. 9). Based on the idle memory size of the GPU, the data transmission/reception module 720 may transmit the prefetched data of the memory of the CPU 700 to the GPU or may receive the delayed offload data from the GPU and store the received delayed offload data in the memory of the CPU 700.

The prefetched data may include input data for an operation to be performed by the GPU. The delayed offload data may include output data that has not been offloaded after the completion of the operation on the GPU. The transmitting of the prefetched data or the receiving of the delayed offload data may be executed in parallel with the operation of the GPU.

According to one or more embodiments, the CPU 700 may include a data transmission thread and an operation assignment thread. The data transmission/reception module 720 may perform data transmission through the data transmission thread. The CPU 700 may perform an operation by assigning an operation task to the GPU through the operation assignment thread.

According to one or more embodiments, the operation of the GPU may include an operation related to a model. Prefetched data may include input data of a layer for the operation related to a model. Delayed offload data may include output data that has not been offloaded after the completion of the operation of a layer of a model.

According to one or more embodiments, the CPU may identify a layer (e.g., a first layer) of the model through the data transmission/reception module 720 as a prefetch layer and may determine whether data prefetching has been completed for the prefetch layer. Based on the determining that the data prefetching has not been completed for each prefetch layer, through the data transmission/reception module 720, the CPU 700 may perform an operation of determining prefetch memory size depending on the operation progress of the GPU that performs the operation related to the model, an operation of transmitting input data for the prefetch layer from the CPU 700's memory to the GPU's memory when the prefetch memory size is less than or equal to the idle memory size of the GPU, and an operation of receiving delayed offload data from the GPU's memory and storing the received delayed offload data in the CPU 700's memory when the prefetch memory size is greater than the idle memory size of the GPU.

According to one or more embodiments, the CPU 700 may include a data size acquisition module (not shown). The data size acquisition module 730 may determine the input data size of each layer of the model and the output data size of each layer of the model.

According to one or more embodiments, through the data transmission/reception module 720, the CPU 700 may identify the current operation layer of the model, which is the target of the operation. Through the data transmission/reception module 720, the CPU 700 may determine the prefetch memory size based on a sum of the input data sizes from the current operation layer to the prefetch layer, the size of the delayed offload data, and a sum of the output data sizes from the current operation layer to the prefetch layer.

According to one or more embodiments, through the memory size acquisition module 710, the CPU 700 may determine a peak value of the memory use of the GPU. Through the memory size acquisition module 710, the CPU 700 may determine the idle memory size of the GPU based on the total memory size of the GPU and the peak value of the memory use of the GPU.

According to one or more embodiments, when the transmitting of the prefetched data and the receiving of the delayed offload data is serially performed with the operation related to the model of the GPU in the initial predetermined number of iterations of the operation related to the model, the CPU 700 may determine the peak value of the memory use of the GPU during the iterations through the memory size acquisition module 710.

FIG. 8 is a block diagram illustrating a GPU according to one or more embodiments.

According to one or more embodiments, the GPU 800 may include a data transmission/reception module 810 and an operation module 820. The data transmission/reception module 810 may receive prefetched data from a CPU (e.g., the CPU 700 of FIG. 7), may store the received prefetched data in the GPU 800's memory, or may transmit delayed offload data from the GPU 800's memory to the CPU. The operation module 820 may perform the operation of the GPU 800 in parallel with the receiving and storing of the prefetched data or the transmitting of the delayed offload data.

The prefetched data may include the input data of a layer for the operation related to a model. The delayed offload data may include output data that has not been offloaded after the completion of an operation of a layer of the model.

According to one or more embodiments, the GPU 800 may include an operation stream (e.g., a CUDA operation stream) and a data copy stream (e.g., a CUDA data copy stream). The GPU 800 may perform the receiving of the prefetched data and the transmitting of the delayed offload data by using the data copy stream through the data transmission/reception module 810. The GPU 800 may perform an operation by receiving an operation task assigned by the CPU by using the operation stream through the operation module 820.

According to one or more embodiments, the operation of the GPU 800 may include an operation related to a model. Prefetched data may include input data of a layer for the operation related to a model. Delayed offload data may include output data that has not been offloaded after the completion of the operation of a layer of a model.

FIG. 9 is a diagram illustrating a data processing apparatus according to one or more embodiments.

According to one or more embodiments, a data processing apparatus may include the CPU 910 (e.g., the CPU 700 of FIG. 7) or the GPU 920 (e.g., the GPU 800 of FIG. 8). The CPU 910 may determine the idle memory size of the GPU 920. Based on the idle memory size of the GPU 920, the CPU 910 may transmit the prefetched data of the memory of the CPU 910 to the GPU 920 or may receive the delayed offload data from the GPU 920 and store the received delayed offload data in the memory of the CPU 910. The GPU 920 may receive prefetched data from the CPU 910, may store the received prefetched data in the GPU 920's memory, or may transmit delayed offload data from the GPU 920's memory to the CPU 910. The GPU 920 may perform the operation of the GPU 920 in parallel with the receiving and storing of the prefetched data or the transmitting of the delayed offload data.

The prefetched data may include input data for an operation to be performed by the GPU 920. The delayed offload data may include output data that has not been offloaded after the completion of the operation on the GPU 920.

According to one or more embodiments, in the data processing apparatus 900 of FIG. 9, the CPU 910 may perform, for example, the data processing method of FIG. 3. The GPU 920 may perform, for example, the data processing method of FIG. 5. The data processing apparatus 900 may perform, for example, the data processing method of FIG. 6. In the data processing apparatus 900, all the details related to the operations performed by the CPU 910 and the GPU 920 are described with reference to FIGS. 1 to 8, and the repeated descriptions thereof are omitted.

The data processing apparatus 900, through multiple threads of the CPU 910 and multiple streams (e.g., multiple CUDA streams), may perform data transmission by sufficiently using PCIe bandwidth resources, and the GPU 920 may perform data prefetching in parallel while executing an operation task. The data processing apparatus 900 may store prefetched data to be used in the operation of the GPU and delayed offload data generated during the operation by dynamically securing and maximally using the GPU 920's idle memory. The data processing apparatus 900 may maximize the GPU 920's operation efficiency by executing data offloading in a timely manner depending on whether the GPU 920's memory is insufficient and whether the prefetched data is sufficient for the GPU 920's operation.

FIG. 10 is a block diagram illustrating an electronic device according to one or more embodiments.

According to one or more embodiments, an electronic device 1000 may be a CPU (e.g., the CPU 700 of FIG. 7 or the CPU 910 of FIG. 9) or a GPU (e.g., the GPU 800 of FIG. 8 or the GPU 920 of FIG. 9). In another example, the electronic device 1000 may include both the CPU and the GPU. The electronic device 1000 may include a memory 1010 (e.g., one or more memories) and a processor 1020 (e.g., one or more processors) including processing circuitry. The memory 1010 may include one or more storage media configured to store instructions. When the instructions are executed individually or collectively by the processor 1020, the electronic device 1000 may be caused to perform the data processing method of the present disclosure. For example, the memory 1010 may include a non-transitory computer-readable storage medium storing code that, when executed by the processor 1020, configures the processor to perform any one, any combination, or all of the operations, methods, and/or steps disclosed herein with reference to FIGS. 1-9.

The electronic device 1000 may not need to be a single electronic device and may be any device or assembly of circuits capable of executing the instructions (or an instruction set) alone or jointly. The electronic device 1000 may also be a part of an integrated control system or a system manager or may be configured as a portable electronic device that locally or remotely (e.g., via wireless transmission) interfaces.

In the electronic device 1000, the at least one processor 1020 may include the CPU, the GPU, a programmable logic device, a dedicated processor system, a microcontroller, or a microprocessor. As a non-limiting example, the processor 1020 may further include an analog processor, a digital processor, a microprocessor, a multicore processor, a processor array, or a network processor.

The processor 1020 may execute the instructions or code stored in the memory 1010. The instructions and the code may also be transmitted and received over a network via a network interface device that may use any known transport protocol, in which the network interface device may use any known transport protocol.

The memory 1010 may be integrated with the processor 1020 by arranging, for example, RAM or flash memory in an integrated circuit microprocessor. In addition, the memory 1010 may include an independent device, such as an external disk drive, a storage array, or other storage devices that may be used by any database system. The memory 1010 and the processor 1020 may be operatively coupled or communicate through an input/output (I/O) port or a network connection such that the processor 1020 may read files stored in the memory 1010.

For example, the electronic device 1000 may further include a video display (e.g., a liquid crystal display (LCD)) and a user interaction interface (e.g., a keyboard, a mouse, or a touch input device). All components of the electronic device 1000 may be connected through a bus and/or a network.

The CPUs, memory size acquisition modules, data transmission/reception modules, GPUs, data transmission/reception modules, operation modules, data processing apparatuses, electronic devices, memories, processors, CPU 700, memory size acquisition module 710, data transmission/reception module 720, GPU 800, data transmission/reception module 810, operation module 820, data processing apparatus 900, CPU 910, GPU 920, electronic device 1000, memory 1010, and processor 1020 described herein, including descriptions with respect to respect to FIGS. 1-10, are implemented by or representative of hardware components. As described above, or in addition to the descriptions above, examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. As described above, or in addition to the descriptions above, example hardware components may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in, and discussed with respect to, FIGS. 1-10 that perform the operations described in this application are performed by computing hardware, for example, by one or more processors or computers, implemented as described above implementing instructions (e.g., computer or processor/processing device readable instructions) or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media, and thus, not a signal per se. As described above, or in addition to the descriptions above, examples of a non-transitory computer-readable storage medium include one or more of any of read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and/or any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above and all drawing disclosures, the scope of the disclosure is also inclusive of the claims and their equivalents, i.e., all variations within the scope of the claims and their equivalents are to be construed as being included in the disclosure.

What is claimed is:

1. A data processing method comprising:
determining an idle memory size of a graphics processing unit (GPU); and
based on the idle memory size of the GPU, selectively performing one of:
transmitting prefetched data of a memory of a central processing unit (CPU) to the GPU; and
receiving delayed offload data from the GPU and storing the delayed offload data in the memory of the CPU,
wherein the prefetched data comprises input data for an operation to be performed by the GPU,
the delayed offload data comprises output data that has not been offloaded after completion of the operation on the GPU, and
the transmitting of the prefetched data or the receiving of the delayed offload data is executed in parallel with the operation of the GPU.

2. The data processing method of claim 1, wherein
the operation of the GPU comprises an operation related to a model,
the prefetched data comprises input data of a layer for the operation related to the model, and
the delayed offload data comprises output data that has not been offloaded after completion of an operation of a layer of the model.

3. The data processing method of claim 2, wherein,
based on the idle memory size of the GPU, the transmitting of the prefetched data of the memory of the CPU to the GPU or the receiving of the delayed offload data from the GPU and the storing of the delayed offload data in the memory of the CPU comprises:
identifying a first layer of the model as a prefetch layer and determining whether data prefetching has been completed for the prefetch layer;
determining a prefetch memory size depending on an operation progress of the GPU configured to perform the operation related to the model, based on the determining that data prefetching has not been completed for the prefetch layer; and
in response to the prefetch memory size being less than or equal to the idle memory size of the GPU, transmitting the input data of the prefetch layer from the memory of the CPU to the memory of the GPU; and
in response to the prefetch memory size being greater than the idle memory size of the GPU, receiving the delayed offload data from the memory of the GPU and storing the delayed offload data in the memory of the CPU.

4. The data processing method of claim 3, further comprising:
in response to the prefetch memory size being greater than the idle memory size of the GPU, and in response to receiving and storing the delayed offload data, based on whether data offloading of all layers of the model has been completed:
terminating a current iteration of the operation related to the model; or
returning to the determining of whether data prefetching has been completed for the prefetch layer.

5. The data processing method of claim 3, further comprising:
in response to the prefetch memory size being less than or equal to the idle memory size of the GPU, and in response to the transmitting of the input data of the prefetch layer:
identifying a second layer, not the first layer, of the model as a prefetch layer; and repeatedly performing the determining of whether prefetching has been completed, the determining of the prefetch memory size, and the transmitting of the input data of the prefetch layer or the receiving of the delayed offload data.

6. The data processing method of claim 3, further comprising:
before the determining of the idle memory size of the GPU, determining an input data size of each layer of the model and an output data size of each layer of the model, and
the determining of the prefetch memory size depending on an operation progress of the GPU configured to perform the operation related to the model comprises:
identifying a current operation layer of the model that is a target of the operation; and
determining the prefetch memory size based on a sum of input data sizes from the current operation layer to the prefetch layer, a size of the delayed offload data, and a sum of output data sizes from the current operation layer to the prefetch layer.

7. The data processing method of claim 6, wherein the determining of an input data size of each layer of the model and an output data size of each layer of the model comprises:
determining the input data size of each layer of the model and the output data size of each layer of the model in a first iteration of the operation related to the model.

8. The data processing method of claim 2, wherein the determining of the idle memory size of the GPU comprises:
determining a peak value of memory use of the GPU; and
determining the idle memory size of the GPU based on a total memory size of the GPU and the peak value of memory use of the GPU.

9. The data processing method of claim 8, wherein the determining of the peak value of memory use of the GPU comprises:
when the transmitting of the prefetched data and the receiving of the delayed offload data is serially performed with the operation related to the model of the GPU in an initial predetermined number of iterations of the operation related to the model, determining the peak value of memory use of the GPU during the initial predetermined number of iterations.

10. A non-transitory computer-readable storage medium storing code that, when executed by the CPU, configures the CPU to perform the method of claim 1.

11. A data processing method comprising:
selectively performing one of:
receiving prefetched data from a central processing unit (CPU) and storing the prefetched data in a memory of a graphics processing unit (GPU), and
transmitting delayed offload data of the memory of the GPU to the CPU; and
performing an operation of the GPU in parallel with the receiving and storing of the prefetched data or the transmitting of the delayed offload data,
wherein the prefetched data comprises input data of the operation to be performed by the GPU, and the delayed offload data comprises output data that has not been offloaded after completion of operation on the GPU.

12. The data processing method of claim 11, wherein the GPU comprises an operation stream and a data copy stream,
wherein the GPU performs the receiving of the prefetched data and the transmitting of the delayed offload data through the data copy stream and performs the operation of the GPU by receiving an operation task assigned by the CPU through the operation stream.

13. The data processing method of claim 11, wherein
the operation of the GPU comprises an operation related to a model,
the prefetched data comprises input data of a layer for the operation related to the model, and
the delayed offload data comprises output data that has not been offloaded after completion of an operation of a layer of the model.

14. A data processing apparatus comprising:
a central processing unit (CPU) configured to:
determine an idle memory size of a graphics processing unit (GPU); and
based on the idle memory size of the GPU, selectively perform one of:
transmitting prefetched data of a memory of the CPU to the GPU; and
receiving delayed offload data from the GPU and store the delayed offload data in the memory of the CPU,
wherein the prefetched data comprises input data for an operation to be performed by the GPU,
the delayed offload data comprises output data that has not been offloaded after completion of the operation on the GPU, and
the transmitting of the prefetched data or the receiving of the delayed offload data is executed in parallel with the operation of the GPU.

15. The data processing apparatus of claim 14, further comprising the GPU, wherein the GPU is configured to:
selectively perform one of:
receiving prefetched data from the CPU and store the prefetched data in a memory of the GPU, and
transmitting delayed offload data of the memory of the GPU to the CPU; and
perform an operation of the GPU in parallel with the receiving and storing of the prefetched data or the transmitting of the delayed offload data.

16. The data processing apparatus of claim 14, wherein
the operation of the GPU comprises an operation related to a model,
the prefetched data comprises input data of a layer for the operation related to the model, and
the delayed offload data comprises output data that has not been offloaded after completion of an operation of a layer of the model.

17. The data processing apparatus of claim 16, wherein, based on the idle memory size of the GPU, for the transmitting of the prefetched data of the memory of the CPU to the GPU or for the receiving of the delayed offload data from the GPU and the storing of the delayed offload data in the memory of the CPU, the CPU is configured to:
identify a first layer of the model as a prefetch layer and determining whether data prefetching has been completed for the prefetch layer;
determine a prefetch memory size depending on an operation progress of the GPU configured to perform the operation related to the model, based on the determining that data prefetching has not been completed for the prefetch layer;
in response to the prefetch memory size being less than or equal to the idle memory size of the GPU, transmit the input data of the prefetch layer from the memory of the CPU to the memory of the GPU, and
in response to the prefetch memory size being greater than the idle memory size of the GPU, receive the delayed offload data from the memory of the GPU and storing the delayed offload data in the memory of the CPU.

18. The data processing apparatus of claim 17, wherein the CPU is further configured to, in response to the prefetch memory size being greater than the idle memory size of the GPU, and in response to receiving and storing the delayed offload data, based on whether data offloading of all layers of the model has been completed, selectively perform one of:
terminating a current iteration of the operation related to the model; and
returning to the determining of whether data prefetching has been completed for the prefetch layer.

19. The data processing apparatus of claim 17, wherein the CPU is further configured to, in response to the prefetch memory size being less than or equal to the idle memory size of the GPU, and in response to the transmitting of the input data of the prefetch layer:
identify a second layer, not the first layer, of the model as a prefetch layer; and
repeatedly performing the determining of whether prefetching has been completed, the determining of the prefetch memory size, and the transmitting of the input data of the prefetch layer or the receiving of the delayed offload data.

20. The data processing apparatus of claim 17, wherein the CPU is configured to:
before the determining of the idle memory size of the GPU, determine an input data size of each layer of the model and an output data size of each layer of the model; and
for the determining of the prefetch memory size depending on the operation progress of the GPU configured to perform the operation related to the model:
identify a current operation layer of the model that is a target of the operation; and
determine the prefetch memory size based on a sum of input data sizes from the current operation layer to the prefetch layer, a size of the delayed offload data, and a sum of output data sizes from the current operation layer to the prefetch layer.
